(19) United States
(12) Patent Application Publication
(10) Pub. No.: US 2009/0073136 A1
(43) Pub. Date: Mar. 19, 2009

(54) INPUTTING COMMANDS USING RELATIVE COORDINATE-BASED TOUCH INPUT

(76) Inventor: Kyung-Soon Choi, Seoul (KR)

Correspondence Address: SEED INTELLECTUAL PROPERTY LAW GROUP PLLC, 701 FIFTH AVE, SUITE 5400, SEATTLE, WA, 98104, US

(21) Appl. No.: 12/211,792

(22) Filed: Sep. 16, 2008

Related U.S. Application Data
(63) Continuation-in-part of application No. PCT/KR2007/003095, filed on Jun. 26, 2007.

(30) Foreign Application Priority Data
Dec. 20, 2006 (KR) KR20060130811
Jan. 19, 2007 (KR) KR20070005945

(51) Int. Cl. G06F 3/041

(52) U.S. Cl. 345/173

(57) ABSTRACT

Methods, techniques, and systems for enhanced processing of touch input are provided. Example embodiments provide a technique for selecting and inputting a command that corresponds to a sequence of relative coordinate values generated by detecting changes in directional movement of a touch position. The user initiates a touch, and as the user moves, the commands corresponding to the sequence of relative coordinate values are displayed. Once the user terminates the touch, the last displayed command is effectively selected and processed as input. Accordingly, a user can input a desired command, character, symbol, etc. using a single gesture, without having to touch the input device to select commands located in fixed positions. Thus, the process of searching for, selecting, and inputting a desired command can be accomplished using just one gesture.

### TECHNICAL FIELD

This disclosure relates to methods, apparatuses, and techniques for inputting commands. In particular, this disclosure relates to inputting commands using touch input.

### BACKGROUND

Typically, information processing devices are equipped with a keyboard or a keypad as an apparatus for inputting various text such as characters, commands, control codes or arrays thereof. On the other hand, for mobile devices, the area that can be allocated for user input is much smaller, and so keypads are employed with relatively smaller dimensions and with fewer keys and buttons. However, due to the fewer number of buttons on the keypads of mobile devices, each button is usually responsible for the entry of multiple characters. As a result, input of a particular character on a mobile device requires the troublesome task of pressing multiple buttons on the keypad, sometimes more than once. Also, for those mobile devices employing keypads, even though their keypads encompass a smaller area, the very existence of a keypad severely limits the size of the displays on these devices.

Up until now, touch-based text inputting apparatuses typically employed the approach of displaying the text (such as text-based commands) that can be entered at fixed positions on a touch pad or touch screen, and inputting the command that corresponds to the text displayed at the position a user touches (i.e., inputting the command thus selected by the user). However, as with the use of keypads on mobile devices, because such touch screens and touch pads are usually limited in size, it is typically impractical to display the entire set of text commands that can be entered on the touch area. To account for this, a given fixed position on the touch area is either simultaneously mapped to the entry of multiple text commands or mapped to the entry of a single text command that changes depending on a menu selection. As a result, multiple touches are often required by a user to input a desired command. Further, if a larger number of text commands are displayed on screen to decrease the number of required touches, it becomes easier to input the wrong command as each occupies a smaller area.

On the other hand, there are touch-based inputting apparatuses that input a text command by recognizing the pattern of movement (e.g., a gesture) along the touch surface, but this method still suffers from the complexity and inaccuracy of current pattern recognition techniques. Furthermore, this method has a high chance of introducing input errors that result from unintentional touch using the touch pad or touch screen.

### BRIEF SUMMARY

In example embodiments, methods, techniques, and apparatuses are provided for inputting a command using a touch input device having a touch-sensitive area. Once an initial touch with the touch input device is made and as the touch position is moved (e.g., by a user), position information corresponding to the touch positions is used to cause sequential generation of a series of commands (symbols, characters, etc.) until a command is indicated for processing. More specifically, the commands that correspond to positions relative to the initial touch are retrieved from storage and are displayed (typically temporarily) on a designated area of the display until a command is indicated for processing, for example, by a touch termination signal.

Other comparable methods, systems, and computer program products may similarly be provided.

### BRIEF DESCRIPTION OF THE DRAWINGS

FIG. 1 is an example block diagram of an example apparatus for inputting a command according to an example embodiment.

FIG. 2A illustrates a mobile device equipped with an example apparatus for inputting a command according to an example embodiment.

FIG. 2B illustrates an Internet protocol television (IPTV) as an example distributed information processing device that executes a method for inputting a command according to an example embodiment.

FIG. 3 is an example block diagram of an apparatus for implementing an example distributed information processing device for inputting a command according to another example embodiment.

FIG. 4 is an example flow diagram illustrating an overall technique for inputting a command according to example embodiments.

FIGS. 5A through 5D are example flow diagrams illustrating aspects S20 through S40 of FIG. 4.

FIGS. 6A through 6D illustrate an example technique for generating movement direction codes from a gesture according to an example embodiment.

FIGS. 7A through 7C illustrate example mappings between commands and relative coordinate values in one or more command data stores according to example embodiments.

### DETAILED DESCRIPTION

Embodiments described herein provide enhanced methods, techniques, and apparatuses for inputting commands using single gestures on a touch-sensitive input device. Example embodiments provide techniques for selecting and inputting a command that corresponds to a relative coordinate value (such as relative coordinates, one or more address pointers corresponding to the relative coordinates, or one or more codes assigned to the relative coordinates, etc.) generated by detecting changes in the directional movement of a touch position. Accordingly, a user can input a desired character, command, control code, or an array or collection thereof using a single gesture (a one time touch and movement from the contact position) along a touch-sensitive area of a touch input device, thereby providing techniques for utilizing the touch-sensitive area efficiently. An intuitive user interface is provided that allows inputting a command by selecting a desired command similar to how a user selects from a sheet table using a finger. The user simply initiates a touch and then terminates the touch on a touch pad or a touch screen at the instant that a desired command is displayed, and the command is then input for processing. Thus, the process of searching for, selecting, and inputting a desired command can be accomplished using just one gesture. Also, the touch sensitive area is more efficiently utilized by allocating predefined commands at relative coordinates that are positioned relative to an initial touch position rather than at fixed positions on the touch input device. Further, various forms and instances of command “menus” can be configured without using conventional fixed-position-based command menu techniques.

Embodiments also provide techniques for reducing input errors that result from unintentional touch of the touch pad or touch screen while a user inputs a command using a touch input device. For example, input errors that result from unintentional touch movement can be reduced, because the next movement direction code or relative coordinate value is generated only when the touch position moves by more than a determined distance. Similarly, a user can avoid the inconvenience of double checking the desired command and the multiple touches required to input a desired command when using a small keypad.

Example embodiments provide additional advantages. For example, two command inputting procedures can be implemented simultaneously by tracing two touch position movements at a time so that a user may use two hands to input commands. Also, IPTV and CATV embodiments allow multi-channel or multi-folder movement, as well as one channel movement. Such systems also allow easier selection of a desired control code from among a plurality of control codes as compared to the conventional soft key type universal remote controllers or other fixed position sensing based input devices. In addition, the techniques used herein take advantage of a user's ability to search using finger movement memorization or voice navigation instead of just searching using eyesight.

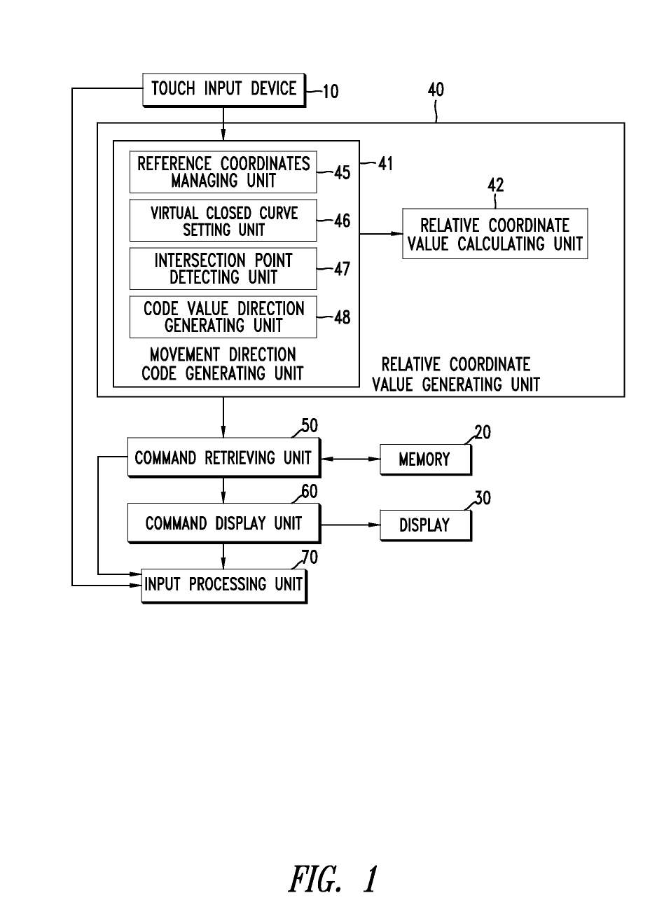

FIG. 1 is an example block diagram of an example apparatus for inputting a command according to an example embodiment. As shown in FIG. 1, an example apparatus for inputting a command includes a touch input device 10, a memory 20, a display 30, a relative coordinate value generating unit 40, a command retrieving unit 50, a command display unit 60, and an input processing unit 70. The apparatus may be realized in a self-contained information processing device, such as a mobile device, or also may be realized in an information processing device composed of multiple components such an Internet Protocol television (IPTV). In addition, the apparatus may be realized in a distributed information processing system (not shown) where several of the multiple components reside on different portions of the system. Further, the relative coordinate value generating unit 40, the command retrieving unit 50, the command display unit 60, and the input processing unit 70 may be implemented using a processor (not shown) provided in the information processing device and/or related software or firmware.

The touch input device 10 has a touch-sensitive area, wherein once initial touch with the touch-sensitive area is made and as the position of the touch (the touch location or touch position) is changed (e.g., by movement of a finger or pointing device), the touch input device 10 generates position information corresponding to the touch positions (i.e., the movement). In addition, the touch input device 10 generates a touch termination signal when the existing touch with the touch-sensitive area is terminated or when the touch pressure or touch area (e.g., the width of the area of touch contact) changes by a value greater than a predetermined value. Here, the generated position information may be fixed coordinates on a designated touch-sensitive area or may be a relative movement distance with a value indicating direction. The touch input device 10 employed may be a conventional touch pad or touch screen or it may be any new device that generates position information in response to touch on a touch-sensitive area and movement along the touch-sensitive area.

At least one command data store consisting of mappings between commands and relative coordinate values is stored in the memory 20. The commands may include characters, strings, control codes, symbols, data, or arrays thereof. The generation of relative coordinate values and the mappings between commands and relative coordinate values are described in more detail below.

The display 30 may be a liquid crystal (LCD) display or an organic light emitting diode (OLED) display, or other display that can display the selectable commands visually.

The relative coordinate value generating unit 40 sequentially receives position information corresponding to touch positions, which is transmitted by the touch input device 10, and sequentially generates a series of relative coordinate values relative to the initial touch position using the position information. According to an exemplary embodiment, the relative coordinate value generating unit 40 may include a movement direction code generating unit 41 and a relative coordinate value calculating unit 42.

The movement direction code generating unit 41 sequentially generates a series of movement direction codes that correspond to movement directions that are derived from the position information corresponding to touch positions, which is received from the touch input device 10. The movement direction code generating unit 41 may include a reference coordinates managing unit 45 for storing the initial touch position received from the touch input device 10 as the reference coordinates position for generating subsequent relative coordinates; a virtual closed curve setting unit 46 for establishing a virtual closed curve around the reference coordinates stored by the reference coordinates managing unit 45; an intersection point detecting unit 47 for detecting whether or not position information that corresponds to a touch position, which is received from the touch input device 10, intersects the virtual closed curve established by the virtual closed curve setting unit 46 and, when an intersection occurs, setting the intersection point as the new reference coordinates of the reference coordinates management unit 45; and a direction code value generating unit 48 for generating the movement direction code that corresponds to the position on the virtual closed curve where the intersection occurred. Each movement direction code may correspond to a vector that describes the movement relative to a reference position indicated by the reference coordinates. For example, a movement of a touch position to the right (relative to a reference position), having a movement direction code of “1,” may correspond to a vector of “(1,0)”.

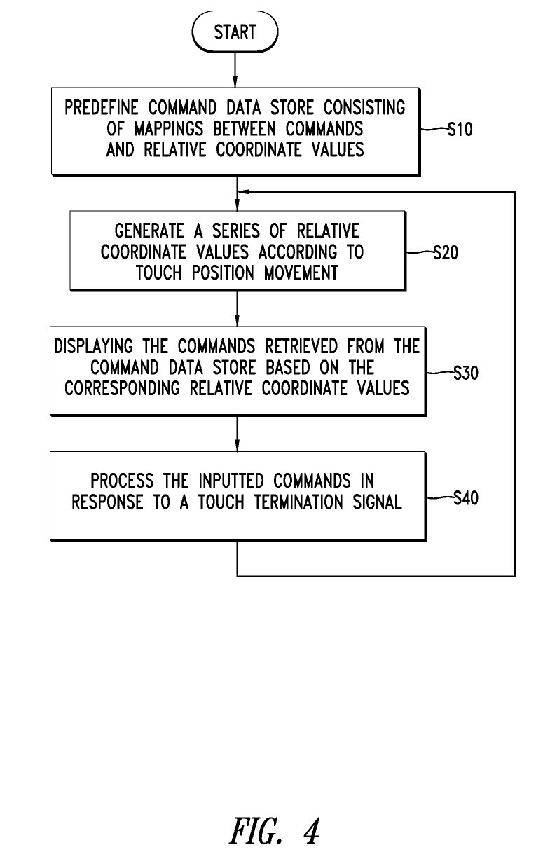

The relative coordinate value calculating unit 42 generates a relative coordinate value by combining (e.g., summing) the vectors that correspond to a series of movement direction codes that are generated sequentially by the movement direction code generating unit 41, as touch position information is received from the touch input device 10. Here, the generated relative coordinate value may be represented not only as relative coordinates but also in the form of an address pointer that corresponds to the relative coordinates indicated by a combination of a series of movement direction codes. The relative coordinate value calculating unit 42 may also generate a relative coordinate value by producing a predefined code indicating the relative coordinates produced by a combination of the movement direction codes. Some examples ways to represent relative coordinate values are described below with reference to FIG. 4.

The command retrieving unit 50 retrieves a series of commands that correspond to the sequentially generated series of relative coordinate values from the command data store stored in the memory 20. Here, the command data store may include sufficient information to indicate the symbol, code, character, text, graphic, etc. to be displayed in response to a relative coordinate value (a relative position), as well as the command to be processed when the displayed symbol, code, character, text, graphic, etc. is selected, and other information as helpful. Accordingly, the data store may store the value to be displayed, the corresponding relative coordinate value, as well as an indication of the actual command to process.

The command display unit 60 temporarily displays the retrieved commands on a designated area of the display 30.

The input processing unit 70 processes as input the command that corresponds to the relative coordinate value generated just before a touch (a gesture) is terminated as a touch termination signal is received from the touch input device 10 (i.e., the “selected” command). If the input-processed command is a phoneme composed of a 2-byte character such as Korean character, the input processing unit 70 may also perform a character combining process using a character combination automata.

Thus, when the command inputting process is implemented using an apparatus such as shown in FIG. 1, normally, the input of one command is accomplished by just one gesture in which a user initially touches the touch-sensitive area using the touch input device 10, moves along the touch-sensitive area (moving the touch position), and terminates the touch to select a desired command. It will be understood that the touch can occur using any known method for using a touch input device such as touch input device 10, and including but not limited to fingers, pointing devices, touch screen pens, etc.

According to another exemplary embodiment, one or more additional actions for inputting a command, such as for inputting a control code corresponding to the “Enter key,” may be needed before the input is processed by the input processing unit 70. For example, when using a remote control for an IPTV, a user may change or select the TV channel by touching and gesturing to input a TV channel number or by touching and gesturing to input the control code corresponding to “Enter key” after inputting the channel number.

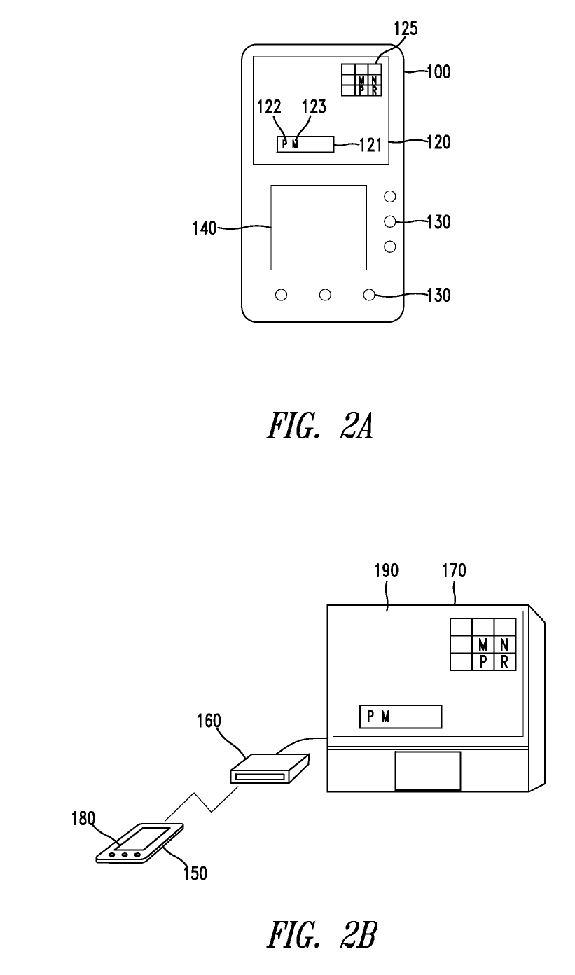

FIG. 2A illustrates a mobile device equipped with an example apparatus for inputting a command according to an example embodiment. In FIG. 2A, mobile device 100 includes an LCD display 120, a few input buttons 130, and a touch pad 140 as a touch input device. The characters 123 with a corresponding character matrix 125 as a character navigation map are displayed on a designated area of the LCD display 120 as a corresponding relative coordinate value is generated.

FIG. 2B illustrates an Internet protocol television (PTV) as an example distributed information processing device that executes a method for inputting a command according to an example embodiment. As shown in FIG. 2B, an IPTV 170 is connected to an associated set-top box 160, which works with a remote control 150 to process command input. The set-top box 160 controls the IPTV 170 by receiving from the remote control 150 control codes that control functions such as channel up & down, volume up & down, service menu display, previous channel or PIP display, etc. The remote control 150 is equipped with a touch pad 180 for receiving touch input. The set-top box 160 receives the control codes associated with the touch input, processes them, and causes appropriate commands to be displayed on a display 190 of the IPTV 170.

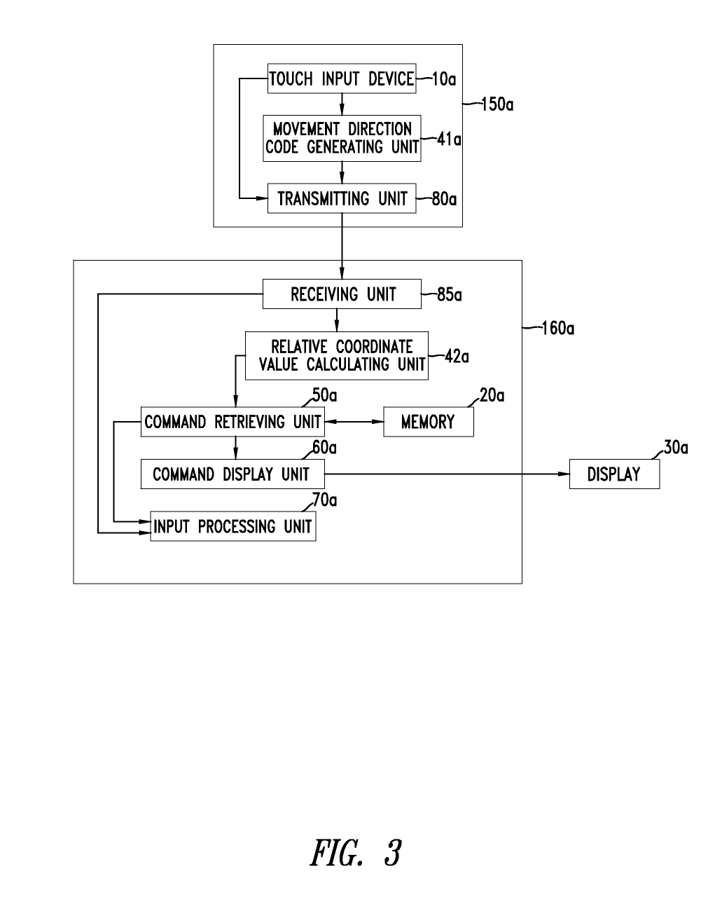

FIG. 3 is an example block diagram of an apparatus for implementing an example distributed information processing device for inputting commands according to an example embodiment, such as used to implement the IPTV device shown in FIG. 2B. As shown in FIG. 3, the apparatus includes remote control 150a, such as remote control 150 of FIG. 2B, and a set-top box 160a, such as the set-top box 160 of FIG. 2B.

The example remote control apparatus 150a for inputting a command includes a touch input device 10a, a movement direction code generating unit 41a, and a transmitting unit 80a. The movement direction code generating unit 41a is typically implemented using a processor (not shown) provided in the remote control apparatus 150a along with related software.

The touch input device 10a includes a dedicated touch-sensitive area, and, when a user touches the dedicated touch-sensitive area with a finger or a pen and moves along the touch-sensitive area, touch position information is generated. In addition, the touch input device 10a generates a touch termination signal when existing touch with the touch-sensitive area is terminated or when touch pressure or touch area (e.g., the width of the area of touch contact) changes by a value greater than a predetermined value.

The movement direction code generating unit 41a sequentially generates a series of movement direction codes that correspond to movement directions derived from the touch position information received from the touch input device 10a.

In this case, as described with reference to in FIG. 1, the movement direction code generating unit 41a may also include a reference coordinates managing unit 45, a virtual closed curve setting unit 46, an intersection point detecting unit 47, and a direction code value generating unit 48, which operate similarly to those described above.

The transmitting unit 80a encodes and transmits to the set-top box 160a a series of movement direction codes sequentially generated by the movement direction code generating unit 41a and a touch termination signal when it is received from the touch input device 10a.

The set-top box 160a, connected to the IPTV 170, includes a receiving unit 85a for receiving the encoded movement direction codes and the touch termination signal from the remote control 150a and then decoding them; a memory 20a; a relative coordinate value calculating unit 42a; a command retrieving unit 50a; a command display unit 60a; and an input processing unit 70a that processes retrieved commands and causes the display of the selected command on a display 30a (for example, display 30 connected to the IPTV 170). The set-top box 160a having the memory 20a, the relative coordinate value calculating unit 42a, the command retrieving unit 50a, the command display unit 60a, and the input processing unit 70a performs similarly to the apparatus described with reference to FIG. 1 to generate (calculate, or otherwise determine) relative coordinate values based upon the received movement direction codes and to cause the display of commands mapped to the generated relative coordinate values on the display 30a.

In another example embodiment, it is possible for the remote control 150a to provide a command inputting apparatus equipped with a similar relative coordinate value generating unit to the one (relative coordinate value generating unit 40) shown in FIG. 1 instead of the movement direction code generating unit 41a shown in FIG. 3. In that case, the transmitting unit 80a in the remote control 150a may encode and transmit both a series of relative coordinate values sequentially generated by the relative coordinate value generating unit and the touch termination signal received from the touch input device. The set-top box 160a is then similarly modified to accept relative coordinate values in the receiving unit 85a, and to forward them to the command retrieving unit 50a (without the relative coordinate value calculating unit 42a).

An example technique for inputting one or more commands corresponding to generated relative coordinate values corresponding to touch position movement along a touch input device is now described referring to the remaining figures.

FIG. 4 is an example flow diagram illustrating an overall technique for inputting a command according to the above described example embodiments. As shown in FIG. 4, the overall technique (i.e., method) is divided into four parts (processes):

First, predefining in memory a command data store consisting of mappings between commands and relative coordinate values (S10)

Second, generating a series of relative coordinate values corresponding to touch position movement (S20).

Third, displaying the commands retrieved from the command data store based on their corresponding relative coordinate values (S30).

Forth, processing the command input in response to a touch termination signal (S40).

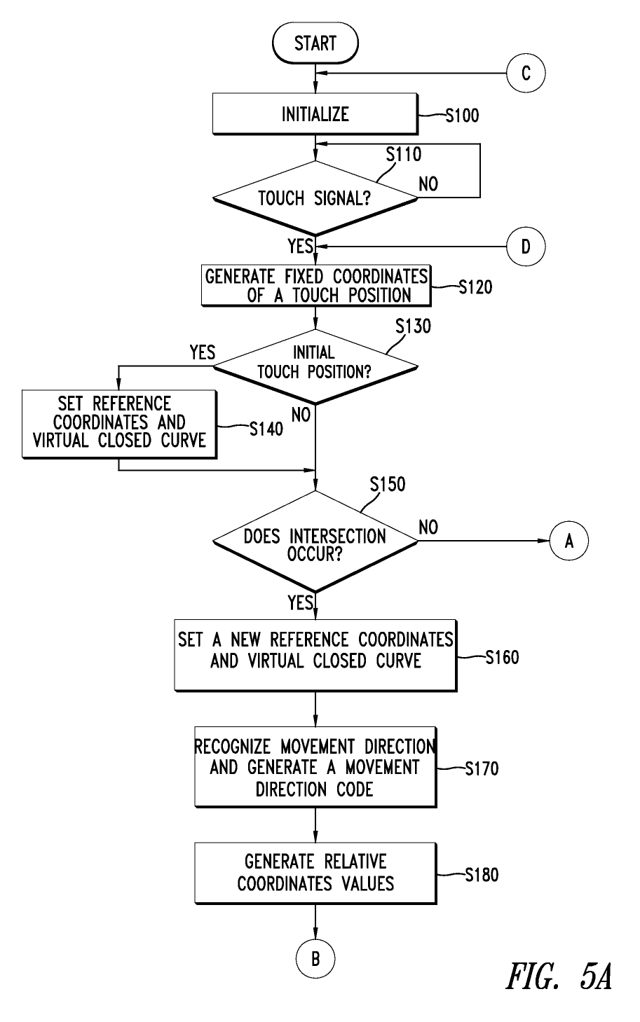

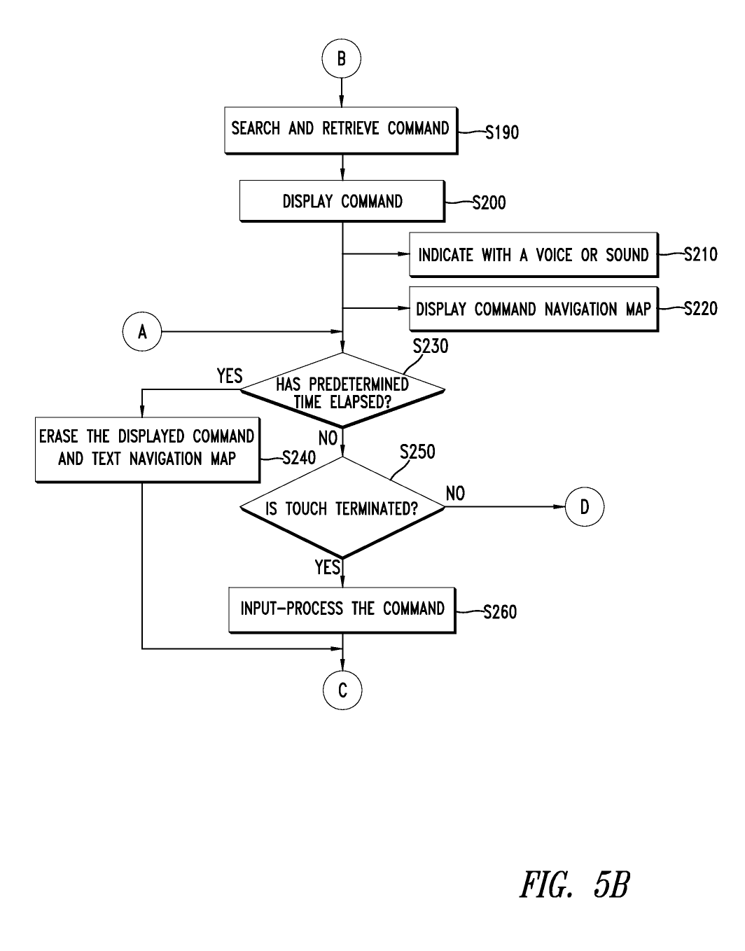

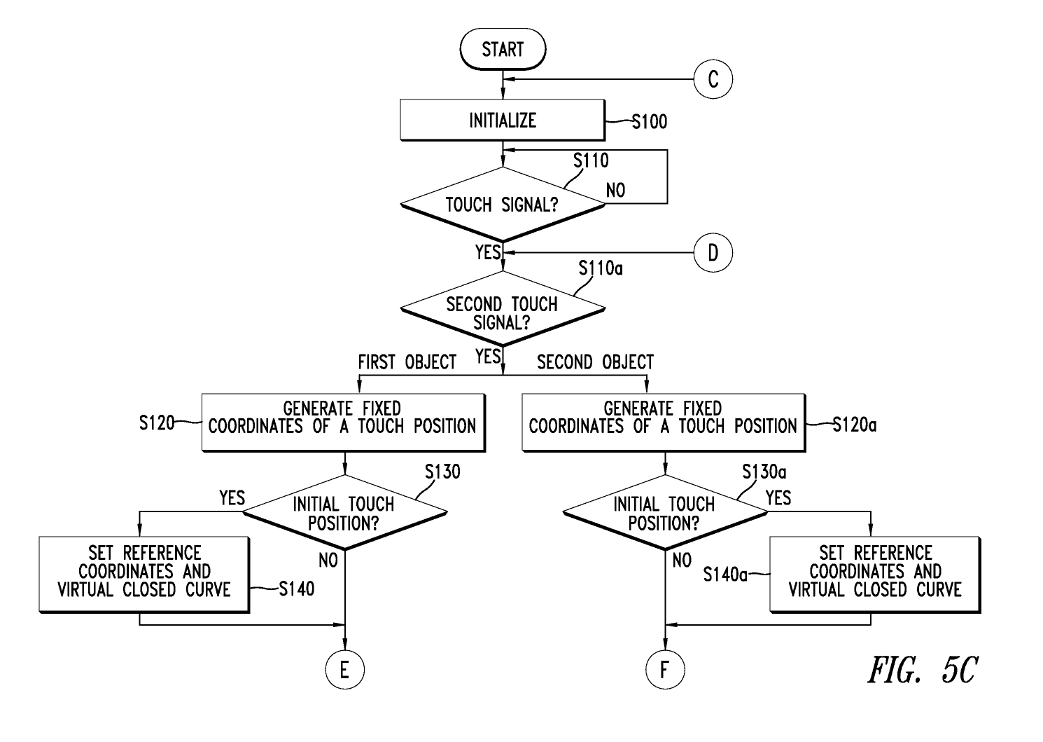

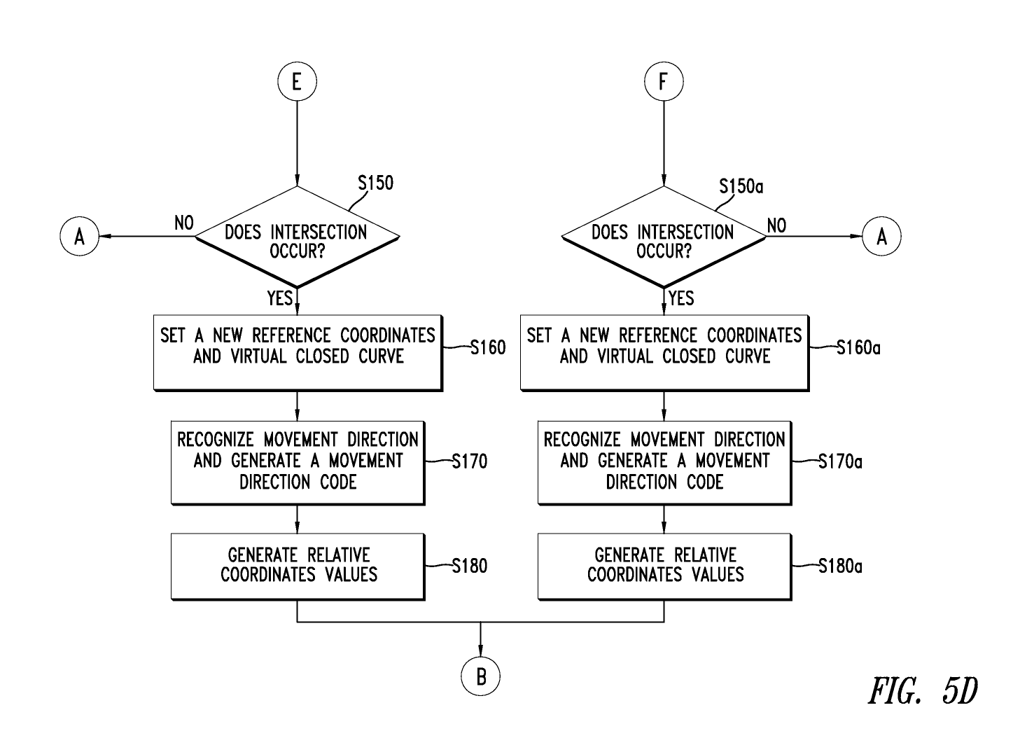

The processes S20 through S40 are described further with respect to FIGS. 5A and 5B. According to one example embodiment, the process S20 for generating a series of relative coordinate values corresponding to touch position movement is subdivided into 1) the process for generating (or otherwise determining) a series of movement direction codes sequentially and 2) the process for generating (or otherwise determining) a series of relative coordinate values sequentially using a the series of movement direction codes.

As stated earlier, a relative coordinate value may be represented, for example, as relative coordinates relative to the initial touch position, a displacement of the fixed coordinates by touch position movement, or a value corresponding to the relative coordinates. For example, the following forms may be used to represent a relative coordinate value:

A) a form of relative coordinates (X), (X,Y) or (X,Y,Z), etc. of which X, Y or Z represent X coordinate, Y coordinate or Z coordinate relative to an initial touch position.

B) a form of an address pointer corresponding to a displacement of fixed coordinates or a form of memory address pointer corresponding to the relative coordinates generated to correspond to a combination of a series of movement direction codes. For example, address 3110 or address 3230 could be address pointers corresponding to the relative coordinates (a1, b1) or (a2, b2), respectively. In an exemplary embodiment, when a touch position is moved to upper right, right, and upper right direction consecutively from an initial touch position, a series of movement direction codes (corresponding vectors thereof) for upper right (1, 1), right (0, 1), and upper right (1, 1) are generated sequentially. In turn, a series of relative coordinate values (1, 1), (1, 2), and (2, 3) are generated sequentially by summing the vectors corresponding to the series of movement direction codes above, and the addresses 3110, 3120 and 3230 may be generated according to a memory address assigning policy of the apparatus to which the address pointers corresponding to the relative coordinates (1, 1), (1, 2) and (2, 3) refer. Note in this example, that the (1,1), (1,2), and (2,3) vectors are embedded between the 3xx0 memory addresses.

C) A form of a code assigned to a displacement of the fixed coordinates corresponding to touch position movement or relative coordinates corresponding to a combination of a series of movement direction codes. For example, relative coordinate values may be represented in a form of code such as “111” or “112”. In this case, the code “111” or “112” corresponds to the relative coordinates (a3, b3) or (a4, b4) respectively. According to at least one exemplary embodiment, when a series of relative coordinate values are transmitted as a code form of “111” or “112” instead of a coordinate form of (1, 1) or (1, 2) from a remote control to an information processing device like set-top box, the device that receives the code form of the relative coordinate values recognizes the code form of “111” or “112” as the relative coordinates (1, 1) or (1, 2). In this case, the remote control may generate “111” or “112” as relative coordinate values indicating the relative coordinates (1, 1) or (1, 2) that correspond to the touch position movement on the touch input device.

FIG. 5A describes the process for generating movement direction codes according to touch position movement. When a user presses a button on the mobile device 100 of FIG. 2A or on the remote control 150 of FIG. 2B to change into the command input mode, the corresponding software, firmware, or hardware process within the apparatus that inputs and processes commands according to exemplary techniques starts the initialization step (S100). Then, the process checks whether or not a touch signal has been generated (e.g., using the touch input device 10 or 10a) (S110). If a touch signal has been generated, the process checks again whether or not position information received from the input device corresponds to an initial touch position or not (S120, S130). If the position information corresponds to the initial touch position, this position information is stored as reference coordinates for subsequent relative coordinates, and a virtual closed curve is established around these coordinates (S140). In this instance the virtual closed curve may be a curve whose size and shape may be predetermined or it may be then derived, for example, using some kind of function or lookup table. Also, for example, the virtual closed curve may be a circle or a polygon around the reference coordinates and the size and/or shape of it may or may not be changed at different stages of generating relative coordinate values.

When the position information corresponding to the touch position received from the touch input device 10 or 10a intersects the virtual closed curve established by the virtual closed curve setting unit 46 (S150), the process sets this intersection point as the new reference coordinates and establishes a new virtual closed curve around the new reference coordinates (S160). The movement direction is ascertained based upon (implicitly, the direction from the prior reference coordinate to) the intersection position on the previous closed curve. Accordingly, the associated movement direction code assigned to that position on the prior virtual closed curve thereof is generated (S170).

This process for sequentially generating movement direction codes based upon touch position movement is repeated until a predetermined time passes or a touch termination signal is received or until some other point.

FIGS. 5C and 5D show a process for generating two series of relative coordinate values respectively based on simultaneous touch position movement by two objects. In one example embodiment, after the initialization step (S100), the process for inputting a command checks whether or not a touch signal has been generated (e.g., using the touch input device 10 or 10a) (S110). If a touch signal has been generated, it checks again whether or not another touch signal has been received that indicates a touch position away from (distinct from) the position where the first touch was placed (S110a).

In this case, the differentiating of the two touch signals is performed by determining whether or not the position of the another touch signal is adjacent to the previous one. If in step S110a, it determines that there is no second touch signal, the process for generating the relative coordinate values (S120 through S180) for one object is continuously performed as described with reference to FIG. 5A and in FIG. 5B. If in step S110a, the process determines that there a second touch signal has been detected, then the process for generating second relative coordinate values (S120a through S180a) for the second object is performed “simultaneously” as described with reference to FIGS. 5C and 5D. Here the objects may refer to fingers, pointing devices or other devices capable of movement on a touch screen separately (whether roughly simultaneous in time, exactly at the same time, or appearing to create separate paths of touch movement). In at least one embodiment each object's relative coordinate values may be generated independently (S180, S180a) based on each object's respective series of movement direction codes (S170, S170a), however the respective commands may be retrieved from the data store in relative coordinate value generating order (S190) (regardless of which object resulted the relative coordinate value), displayed on an area of the display (S200), and processed in initial touch order (S260). Other embodiments may process the dual touches in other orders, such as by order of disengagement of the objects from the touch input device.

According to another exemplary embodiment, when the second set of relative coordinate values are generated to correspond to touch movement of the second object, and while the first object does not move along after an initial touch, another corresponding command data store may be selected. For example, this technique may be used to select between an English capital letter mode and a small letter mode or to select between Japanese Hiragana mode and Katakana mode, such as is typically performed by pressing a “Shift” key on a keyboard.

Other handling of multiple object touch movement can be similarly performed.

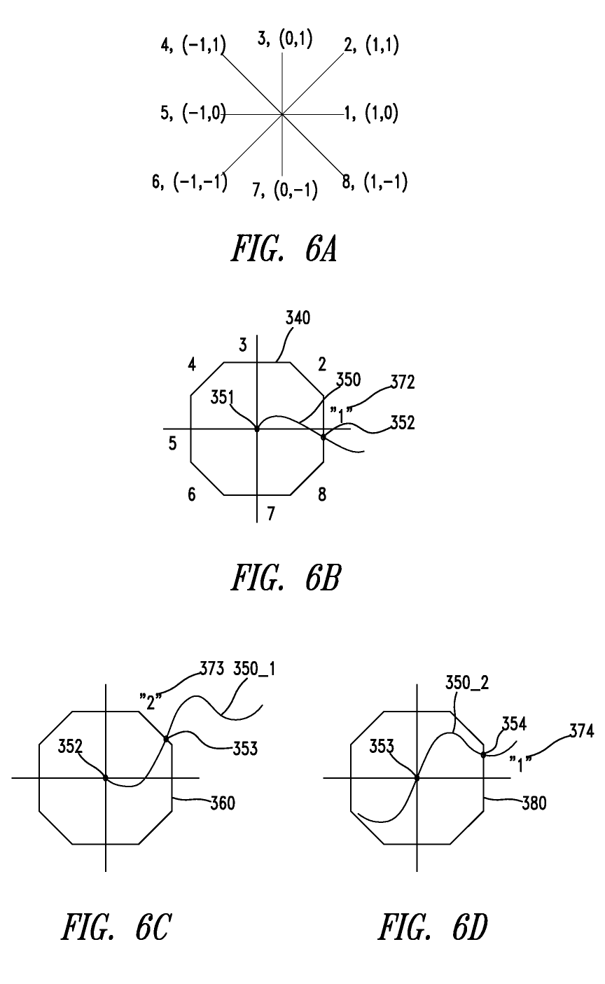

FIGS. 6A through 6D illustrate details of an example technique for generating movement direct codes from a gesture according to an example embodiment.

As shown in FIGS. 6B-6D, a series of touch position movement information may be represented as one continuous line 350 starting from an initial touch position (reference coordinates) 351 upon an initial touch and movement along the touch input device (e.g., touch input device 10 or 10a). After reference coordinates 351 have been set, a virtual closed curve 340 having eight segments such as right, upper right, upper, upper left, left, lower left, lower, and lower right segment is established around the reference coordinates 351 as shown in FIG. 6B. The virtual closed curve 340 may have various shapes, for example a rectangle, a circle, an octagon, as shown in FIG. 6B, or other polygon. As the continuous line 350 starting from the initial touch position 351 intersects the closed curve 340, the intersection point is detected (352) and the movement direction code assigned to the corresponding segment of the virtual closed curve 340 where the intersection occurred is generated. In FIG. 6B, the first movement direction is “right” of the reference coordinates 351, so the movement direction code generated is a “[1]” (372) (see also, FIG. 6A). The intersection point 352 at which line 350 (indicating the touch position movement) intersects is set as the new reference coordinates. (Intersection point 352 in FIG. 6B becomes reference coordinates 352 in FIG. 6C.) Further, as shown in FIG. 6C, a new virtual closed curve 360 around the new reference coordinates 352 is established, which may or may not have the same size and/or shape as that of the previous curve 340.

After the new reference coordinates 352 is set and the new virtual closed curve 360 established, as shown in FIG. 6C, as the continuous line 350_1 representing the series of touch position movement continues and intersects the closed curve 360, a new intersection point 353 is detected. Then, the next movement direction code “[2]” (373), which has been assigned to the segment of the virtual closed curve 360 at which the intersection occurred (the upper right segment), is generated. If the touch position moves consecutively thereafter, as shown in FIG. 6D, a new intersection point 354 is detected, and a movement direction code “[1]” (374) is generated again, as the line 350_2 intersects closed curve 380 at the rightmost segment. In summary, the above-described process causes a series of movement direction codes [1], [2] and [1] to be generated sequentially from an initial touch and subsequent movement along a touch input device (e.g., touch input device 10 or 10a), when an inputting apparatus assigns the movement direction codes to the movement directions as shown in FIG. 6A.

As a series of movement direction codes are generated, a series of relative coordinate values may be produced sequentially by summing the corresponding vectors assigned to the series of movement direction codes (S180). In FIG. 6A, for example, eight vectors of (1,0), (1,1), (0,1), (−1,1), (−1,0), (−1,−1), (0,−1) and (1,−1) are assigned respectively to the eight movement direction codes 1-8. Thus, referring to FIGS. 6B-6D, the first relative coordinate value generated is (1,0), which is the sum of vector (1,0) assigned to the first movement direction code [1] (372). The second relative coordinate value generated is (2,1), which is the sum of vectors (1,0) and (1, 1), which is the sum of the vectors assigned to the first movement direction code [1] (372) with the second movement direction code [2] (373). The third relative coordinate value generated is (3,1), which is the sum of vectors (1, 0), (1, 1) and (1,0), assigned respectively to the first, second, and third movement direction codes [1] (372), [2] (373), and [1] (374).

Referring again to the steps of FIG. 5B, the process (S30 of FIG. 4) for displaying the commands retrieved from the command data store consists of the step of retrieving the commands corresponding to sequentially generated relative coordinate values from the command data store (S190) and the step of displaying the commands on a portion of the display (e.g., display 30 or 30a) (S200). In step S240, if a determined amount of time passes (predetermined, calculated, etc.), or as determined by some other threshold, or if the next relative coordinate value is generated, the displayed command is erased or changed (S240). In step S190, if a corresponding command for a generated relative coordinate value cannot be found in the command data store, then no particular command is displayed nor is any input processed.

In at least one example embodiment, the retrieved command may be indicated with voice or sound (S210) to allow a user to monitor the commands to be input. In the step S220, not only the command corresponding to the generated relative coordinate value, but also the commands that correspond to relative coordinate values that “surround” the generated relative coordinate value (as according to a map implemented by which commands correspond to which coordinate values in the data store) may be displayed on a designated area of the display (e.g., display 30 or 30a), for example, using a matrix form (125) so as to provide a command navigation map. An example of such a navigation map was illustrated in area 125 of FIG. 2A.

When existing touch with the touch-sensitive area is terminated, or when touch pressure or touch area (e.g., the width of the area of touch contact) changes by the value greater than a predetermined one, the touch input device (e.g., device 10 or 10a) generates touch termination signal. Once a touch termination signal is received from touch input device, the input of the command corresponding to the relative coordinate value that was generated to correspond to the touch movement just prior to the touch termination signal is processed (as the selected command) (process S40 of FIG. 4) and the operation returns to the initialization step (S100 of FIG. 5A).

When the commands corresponding to the relative coordinate values are sequentially displayed on the display screen, and if a determined amount of time passes without touch position movement (or other threshold), the command displayed on the display (e.g., display 30 or 30a) is erased (S230, S240) and the operation returns to the initialization step (S100 of FIG. 5A). In this case, the displayed command may not be processed. If a determined amount of time does not pass and the touch termination signal is not generated, it is understood that new position information is under generation in response to touch position movement (S120).

According to some example embodiments, one or more of a plurality of command data stores corresponding to relative coordinate values or movement direction codes may be stored in memory (process S10 of FIG. 4). In this case, in process S30 a single command data store may be selected from among the plurality of command data stores according to the first relative coordinate value or the first movement direction code. The corresponding command that matches the first relative coordinate value or the first movement direction code is then retrieved from the selected command data store and displayed on a designated area of a display (e.g., display 30 or 30a). Starting from the second relative coordinate value thereafter, the command that matches the second relative coordinate value is retrieved from the selected command data store, and displayed sequentially on a designated area of the display (e.g., display 30 or 30a).

According to another example embodiment, a single command data store may be selected from among the plurality of command databases by selecting the data store that corresponds to an initial touch position on a touch input device (e.g., device 10 or 10a). For example, if the touch position moves along the touch screen after an initial touch within the upper area of a touch screen, then the command data store for an “English capital letter mode” may be selected. Meanwhile, if the touch position moves along the touch screen after an initial touch within the lower area of the touch screen, then the command data store for an “English small letter mode” may be selected. Other variations are of course possible.

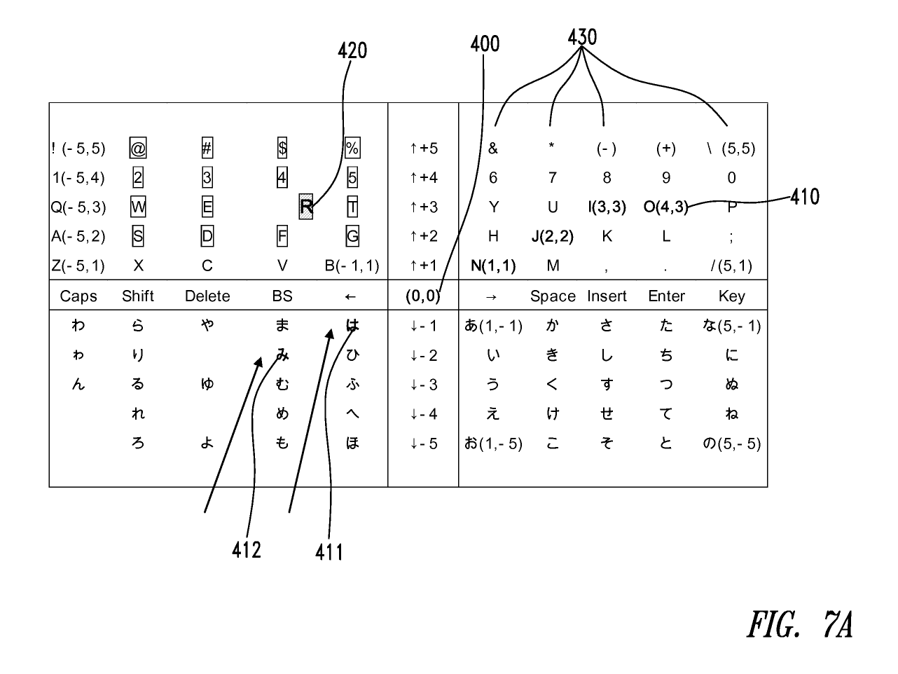

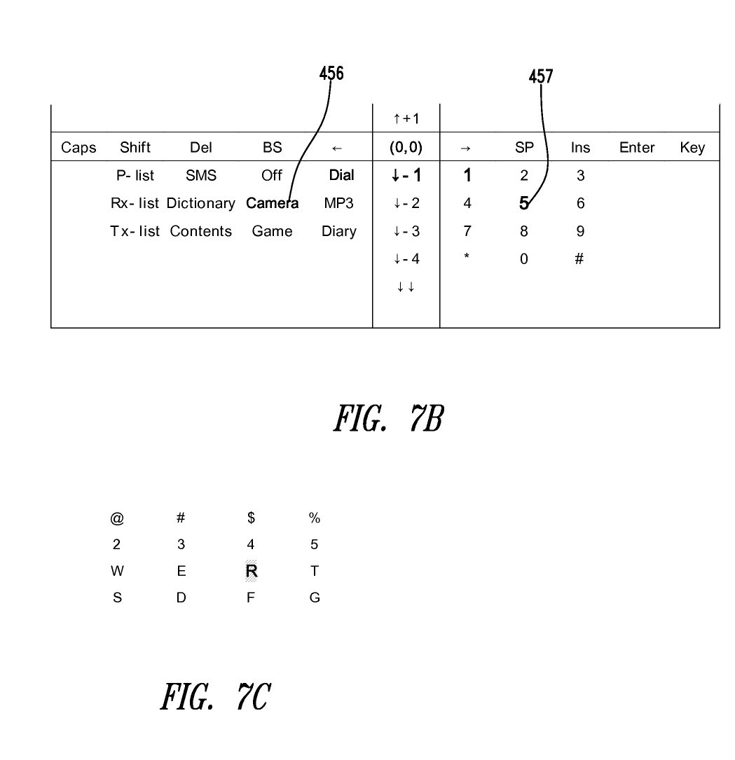

FIGS. 7A through 7C illustrate example mappings between commands and relative coordinate values in one or more command data stores according to example embodiments. As shown in FIG. 7A, a command data store may be predefined in such a way that sentence symbols, numbers, and alphabets may correspond to the relative coordinate values (−5, 5) through (5, 1) of a matrix with similar arrangement to a Qwerty keyboard, and Japanese Hiragana characters may correspond to the relative coordinate values (−5,−1) through (5,−5) of a matrix; and up & down direction codes may correspond to the relative coordinate values (0, 5) through (0,−5) of a matrix. Here, the relative coordinate values are based on the reference coordinates 400 which corresponds to an initial touch position on the touch input device (e.g., device 10 or 10a).

In this example, when a touch position moves consecutively in the directions of upper right, upper right, upper right, and right, a series of movement direction codes of [2], [2], [2] and [1] are generated sequentially (see FIG. 5A). The vectors assigned to the above movement direction codes are (1, 1), (1, 1), (1, 1) and (1,0), respectively, and, accordingly, the sequentially generated relative coordinate values are (1, 1), (2, 2), (3, 3) and (4, 3) by summing the vectors assigned to the above movement direction codes. Then, as shown in FIG. 7A, characters N, J, I, and O (410), which correspond to the sequentially generated relative coordinate values of (1, 1), (2, 2), (3, 3) and (4, 3), are displayed sequentially on the display area of the display (e.g., display 30 or 30a). If a user terminates touch while the character O 410 is displayed, the character O is selected and processed as input.

As shown in FIG. 7B, according to another example, another command data store may be defined with different mappings to the same set of relative coordinate values. In FIG. 7B, the command data store contains a different set of commands corresponding to the same set of relative coordinate values that were shown in FIG. 7A. For example, they may be defined in such a way that control codes for a mobile phone instead of Japanese Hiragana may correspond to the relative coordinate values (−4,−1) through (−1,−3) of a matrix and numbers may correspond to the relative coordinate values (1,−1) through (3,−4). Accordingly, it is possible to assign a different set of characters (and/or symbols) and/or control codes to the same set of relative coordinate values of another command data store by differentiating which command data store is to be used (for example, through the first relative coordinate value or the first movement direction code, or other selection).

For example, when a relative coordinate value (−2,−2) is generated after the first relative coordinate value (−1,−1), the command data store in FIG. 7A can be selected by the first relative coordinate value (−1,−1), so that Japanese character [symbol] 411 and [symbol] 412 corresponding to the relative coordinate values (−1,−1) and (−2,−2) are displayed sequentially. If a user terminates touch while [symbol] 412 is displayed, the character [symbol] is processed as input. As another example, when the relative coordinate value (−1,−1) is generated after the first relative coordinate value (0,−1), and then the relative coordinate value (−2,−2) is generated thereafter, the command data store of FIG. 7B is used instead of that of FIG. 7A. The command data store of FIG. 7B is selected using the first relative coordinate value (0,−1) so that the symbol for “Dial” mode and the symbol for “Camera” mode 456 (corresponding to the relative coordinate values (−1,−1) and (−2,−2), respectively) are displayed sequentially instead of Japanese character [symbol] and [symbol] . When a user terminates the touch while the symbol for “Camera” mode 456 is displayed, the control code for “Camera” mode is processed as input. In turn, the mode of the device may be changed into the “Camera” mode. When a user initially touches the touch input device (e.g., device 10 or 10a) and the relative coordinate values (0,−1), (1,−1) and (2,−2) are generated sequentially, the command data store of FIG. 7B is selected by the first coordinate value (0,−1) so that numbers 1 and 5 (457), which correspond to the coordinates (1,−1) and (2,−2) respectively, are selected and displayed sequentially after displaying the symbol for down arrow as shown in FIG. 7B.

In the step S220 of FIG. 5B, the commands that correspond to the relative coordinate values that surround the generated relative coordinate value may be displayed in a form of a matrix, as described above, so as to provide a command navigational interface. So, for example, in FIG. 7A, when the relative coordinate value (−2, 3) is generated and R (420) is displayed on an area of the display, a command navigation map may also be displayed (see FIG. 7C), in which R (420) is displayed in some sort of highlighted manner. For example, R (420) may be displayed using a “pop-up” display, and command symbols @, #, $, % and 2, 3, 4, 5 and W, E, R, T and S, D, F, G, which surround R (420), may be displayed together in a form of matrix, so as to provide a command navigational interface. When the relative coordinate values are generated sequentially, as has been described here, the pop-up (or other highlighted) displayed command and the “window” of the command navigation map being displayed also moves accordingly across the sequentially generated relative coordinate values.

When the touch position returns to the initial touch position, for example, in a case where the movement direction codes [2] and [6] are generated sequentially, to which vectors (1, 1) and (−1,−1) are assigned respectively, then the second relative coordinate value may become relative coordinates (0,0). In this case, as shown in FIG. 7A, no command is matched to the coordinates (0,0). Thus, no command is processed even though the touch is terminated.

Also, in an example embodiment, when any of relative coordinate values from among (1, 6) through (5, 6) (430) are generated as shown in FIG. 7A, a corresponding command for the generated relative coordinate value cannot be found in the command data store so no particular command is displayed or processed as input even though the touch is terminated.

The example embodiments described herein may be provided as computer program products and programs that can be executed using a computer processor. They also can be realized in various information processing devices that execute instructions stored on a computer readable storage medium. The computer readable storage medium include magnetic recording media, optical recording media, semiconductor memory, and such storage media as transmission means (e.g., transmission through Internet) for transporting instructions and data structures encoding the techniques described herein.

All of the above U.S. patents, U.S. patent application publications, U.S. patent applications, foreign patents, foreign patent applications and non-patent publications referred to in this specification and/or listed in the Application Data Sheet, including but not limited to PCT Patent Application No. PCT/KR2007/003095, filed Jun. 26, 2007, and published as WO2008/075822, are incorporated herein by reference, in their entirety.

From the foregoing it will be appreciated that, although specific embodiments have been described herein for purposes of illustration, various modifications may be made without deviating from the spirit and scope of the present disclosure. For example, the methods, techniques, and systems for performing touch input processing discussed herein are applicable to other architectures other than a touch screen. Also, the methods, techniques, and systems discussed herein are applicable to differing protocols, communication media (optical, wireless, cable, etc.) and devices (such as wireless handsets, remote controllers including universal remote controllers, electronic organizers, personal digital assistants, portable email machines, personal multimedia devices, game consoles, other consumer electronic devices, home appliances, navigation devices such as GPS receivers, etc.).

1. A method for inputting a command using a touch input device, comprising:
receiving a sequence of indications of touch positions, the sequence including an indication of an initial touch position when contact is initiated with the touch input device and including indications of subsequent touch positions as the initial touch position is moved along a surface of the touch input device;
as each indication of a subsequent touch position in the sequence is received, processing the indicated touch position by:
generating a relative coordinate value that reflects a location of the indicated touch position relative to the initial touch position;
retrieving from a data store a command that corresponds to the generated relative coordinate value; and
presenting on a portion of a presentation device the retrieved command; and
when a touch termination signal is received, processing as input the command that corresponds to the most recent relative coordinate value generated before the touch terminal signal was received.

2. The method of claim 1 wherein each subsequent touch position is associated with a movement direction code that corresponds to directional movement of the touch position from a preceding touch position in the sequence, and wherein, as each indication of a subsequent touch position in the sequence is received, the processing the indicated touch position by generating the relative coordinate value that reflects the location of the indicated touch position relative to the initial touch position further comprises:
generating a relative coordinate value of the indicated touch position relative to the initial touch position based at least in part upon the movement direction code associated with the indicated touch position.

3. The method of claim 2 wherein the generating the relative coordinate value of the indicated touch position relative to the initial touch position based at least in part upon the movement direction code associated with the indicated touch position further comprises:
generating a relative coordinate value of the indicated touch position relative to the initial touch position by summing a vector corresponding to the movement direction code associated with the indicated touch position with vectors that correspond to movement direction codes associated with prior touch positions in the received sequence.

4. The method of claim 2, the movement direction codes representing movement in at least one, two, four, or eight directions.

5. The method of claim 1 wherein the relative coordinate values are expressed as at least one of coordinates, pointers, or codes.

6. The method of claim 1, the receiving the sequence of indications of touch positions further comprising:
receiving an indication of an initial touch position;
assigning the initial touch position as a reference coordinate value;
generating a virtual closed shape surrounding the reference coordinate value, the shape comprising one or more segments, each segment a determined location from the reference coordinate value;
detecting when the touch position is moved along the surface of the touch device and a position where the touch position intersects one of the segments of the virtual closed shape;
generating a next indication of a subsequent touch position as part of the sequence of indications of touch positions, based in part on the location of the intersected segment;
resetting the reference coordinate value to the position where the touch position intersected the one of the segments;
repeating the acts of generating the virtual closed shape, detecting when the touch position is moved and intersects one of the segments of the virtual closed shape, generating the next indication of a subsequent touch position as part of the sequence, and resetting the reference coordinate value, until the touch termination signal is received.

7. The method of claim 1 wherein, as each indication of the subsequent touch position in the sequence is received, the processing the indicated touch position by presenting on the portion of the presentation device the retrieved command further comprises:
displaying on a portion of a display device the retrieved command and erasing or modifying the display of the displayed command when a determined amount of time has lapsed or when a next command has been retrieved from the data store that corresponds to a generated relative coordinate value that reflects a location of a next subsequent touch position in the received sequence.

8. The method of claim 1 wherein, as each indication of the subsequent touch position in the sequence is received, the processing the indicated touch position by presenting on the portion of the presentation device the retrieved command further comprises:
displaying on a portion of a display screen a navigation map including other commands in conjunction with the retrieved command.

9. The method of claim 8 wherein the navigation map includes commands that are positioned nearby the retrieved command in a relative coordinate value space.

10. The method of claim 8 wherein the retrieved command is highlighted relative to the other commands in the navigation map, the highlighting including at least one of a visual marking, a pop-up window, or a sound effect.

11. The method of claim 1, wherein, as each indication of the subsequent touch position in the sequence is received, the processing the indicated touch position by presenting on the portion of the presentation device the retrieved command further comprises indicating the retrieved command with a sound, a voice, or other auditory mechanism.

12. The method of claim 1, further comprising:
as each indication of the subsequent touch position in the sequence is received, when the processing the indicated touch position by retrieving from the data store the command that corresponds to the generated relative coordinate value is unable to locate a corresponding command, the presenting on the portion of a presentation device the retrieved command instead does not present a command and no input is processed when the touch termination signal is received.

13. The method of claim 1, wherein the data store is selected from a plurality of data stores using at least one of the initial touch position or the relative coordinate values generated as the subsequent touch positions in the sequence are received, and, as each indication of the subsequent touch position is received, the processing the indicated touch position by retrieving from the data store the command that corresponds to the generated relative coordinate value, further comprises:
retrieving from the selected data store a command that corresponds to the generated relative coordinate value.

14. The method of claim 1, the receiving the sequence of indications of touch positions further including a second initial touch position associated with a second touch object, the initial touch position associated with a first touch object, and the receiving the sequence of indications of touch positions and the processing of each received indication of the subsequent touch position in the sequence, further comprising:
separately tracking the movement of the initial touch position to subsequent touch positions of the first touch object from the movement of the second initial touch position to subsequent touch positions of the second touch object; and
for each separately tracked movement,
generating relative coordinate values to track the movement of the corresponding touch object;
retrieving commands from one or more data stores that correspond to the generated relative coordinate values; and
presenting at least one of the retrieved commands corresponding to movement of at least one of the first or second objects.

15. The method of claim 14 wherein the when the touch termination signal is received, processing as input the retrieved command that corresponds to the most recent relative coordinate value generated before the touch terminal signal was received is processed for one of the two objects.

16. The method of claim 14 wherein, when the separately tracked movement of the initial touch position to subsequent touch positions of the first object indicates no movement after contact is initiated using the first touch object, selecting a data store to be used for retrieving commands corresponding to relative coordinate values generated to track movement of the second touch object.

17. The method of claim 16 wherein the contact is initiated using the first object before contact is initiated using the second touch object.

18. The method of claim 16 wherein the contact is initiated using the first object after contact is initiated using the second touch object.

19. A computer-readable medium containing instructions that, when executed, enable a touch input device to input a command by performing a method comprising:
receiving a sequence of indications of touch position movement, the sequence including an indication of an initial touch position when contact is initiated with the touch input device and including indications of subsequent touch positions as the initial touch position is moved on the touch input device;
generating relative coordinate values that correspond to each indicated touch position in the sequence and that convey a position of the indicated touch position relative to the initial touch position;
retrieving commands from a data store that correspond to the generated relative coordinate values; and
for each received indication of touch position movement, temporarily presenting, on a portion of a presentation device, the retrieved command that corresponds to the relative coordinate value generated to correspond to the indicated touch position; and
when a touch termination signal is received, processing as input the presented command that corresponds to a most recent one of the generated relative coordinate values generated before the touch terminal signal was received.

20. The computer-readable medium of claim 19 wherein the sequence of indications are movement direction codes that correspond to directional movement of each touch position in relation to an immediately preceding touch position in the sequence, and wherein the relative coordinate values are generated based upon the movement direction codes.

21. The computer-readable medium of claim 20 wherein the movement direction codes correspond to movement in at least one, two, four, or eight directions.

22. The computer-readable medium of claim 20 wherein the relative coordinate values are generated by:
assigning an initial reference coordinate value;
repeating,
generating a virtual closed curve shape around the reference coordinate value;
detecting a location at which the touch position movement intersects with the generated virtual closed curve;
assigning a direction movement code to the detected location, the direction movement code corresponding to the direction of intersection relative to the reference coordinate value;
determining a relative coordinate value based upon the assigned direction movement code; and
setting a new reference coordinate value to be the detected location at which the touch position movement intersected;
until a touch termination signal is received.

23. The computer-readable medium of claim 19 wherein the data store comprises a plurality of data stores, selectable by a first reference coordinate value.

24. The computer-readable medium of claim 19, further comprising:
presenting a navigation map of neighboring commands while presenting each temporarily presented retrieved command.

25. The computer-readable medium of claim 19, further comprising:
receiving a second sequence of indications of touch position movement of a second touch object; and
using the second sequence of indications to select an alternative set of characters or symbols.

26. The computer-readable medium of claim 19 wherein the alternative set of characters or symbols selects between upper and lower case letters or between Katakana mode and Hiragana mode.

27. An apparatus for inputting a command corresponding to a relative coordinate value generated by touch position movement, comprising:
a touch input device configured to receive touch contact with and touch position movement along a touch-sensitive area, generate corresponding position information, and generate a touch termination signal;
a data store configured to store mappings between commands and relative coordinate values;
a display;
a relative coordinate value generating unit, wherein once initial touch contact with the touch input device is made, and as the touch position is moved, the touch input device forwards position information of the corresponding touch positions to the relative coordinate value generating unit which is configured to use the position information to sequentially generate a series of relative coordinate values relative to the initial touch position;
a command retrieving unit, which is configured to retrieve from the data store a series of commands that correspond to the sequentially generated series of relative coordinate values;
a command display unit, configured to temporarily display the commands retrieved from the command retrieving unit on a designated area of the display; and
an input processing unit, configured, once the touch termination signal is received from the touch input device, to process the input of the command corresponding to the relative coordinate value that is generated just before the touch is terminated.

28. The apparatus of claim 27, wherein the touch termination signal is generated when existing touch with the touch-sensitive area is terminated or when touch pressure or touch area changes by a value greater than a predetermined one.

29. The apparatus of claim 27, the relative coordinate value generating unit further comprising:
a movement direction code generating unit configured to, once initial touch with the touch input device is made and one or more touch positions are moved along the touch sensitive-area, sequentially generate a series of movement-direction codes that correspond to movement directions derived from position information of the touch positions received from the touch input device; and
a relative coordinate value calculating unit configured to sequentially generate the series of relative coordinate values using the series of movement-direction codes.

30. The apparatus of claim 29, the movement direction code generating unit further comprising:
a reference coordinates managing unit configured to maintain the initial touch position received from the touch input device as reference coordinates for subsequent relative coordinate values;
a virtual closed curve setting unit configured to establish a virtual closed curve around the reference coordinates maintained by the reference coordinates managing unit;
an intersection point detecting unit configured to detect whether or not the touch position information received from the touch input device intersects the virtual closed curve established by the virtual closed curve setting unit and, when an intersection occurs, setting the intersection point as new reference coordinates; and
a code value generating unit, configured to generate, upon detection of an intersection by the intersection point detecting unit, a movement direction code assigned to a position on the virtual closed curve at which the intersection occurred.

31. An apparatus for inputting a command, the apparatus comprising:
a touch input device having a touch-sensitive area, configured to receive touch contact with and touch position movement along the touch-sensitive area, generate corresponding position information, and generate a touch termination signal;
a movement direction code generating unit, configured to, once initial touch with the touch input device is made and one or more touch positions are moved along the touch sensitive area, sequentially generate a series of movement direction codes that correspond to movement directions derived from the position information received from the touch input device; and
a transmitting unit configured to encode and transmit a series of movement direction codes sequentially generated by the movement direction code generating unit and a touch termination signal received from the touch input device.

32. The apparatus of claim 31, wherein the touch termination signal is generated when existing touch with the touch-sensitive area is terminated or when touch pressure or touch area changes by a value greater than a predetermined one.

33. An apparatus for inputting a command, the apparatus comprising:
a touch input device having a touch-sensitive area, configured to receive touch contact with and touch position movement along a touch-sensitive area, generate corresponding position information, and generate a touch termination signal;
a relative coordinate value generating unit, configured to, once initial touch with the touch input device is made and as one or more touch positions are moved, use the position information corresponding to the touch positions forwarded by the touch input device to sequentially generate a series of relative coordinate values relative to an initial touch position; and
a transmitting unit configured to encode and transmit a series of relative coordinate values sequentially generated by the relative coordinate value generating unit and the touch termination signal received from the touch input device.

34. The apparatus of claim 33, wherein the touch termination signal is generated when existing touch with the touch-sensitive area is terminated or when touch pressure or touch area changes by a value greater than a predetermined one.
